(19) United States
(12) Patent Application Publication
(10) Pub. No.: US 2012/0140835 A1
(43) Pub. Date: Jun. 7, 2012

(54) CHANNEL ESTIMATION IN AN OFDM TRANSMISSION SYSTEM

(75) Inventors: Nicolai Czink, Wien (AT); Thomas Zemen, Brunn am Gebirge (AT); Laura Bernadó, Wien (AT); Andreas Molisch, Los Angeles, CA (US)

(73) Assignee: KAPSCH TRAFFICCOM AG, Wien (AT)

(21) Appl. No.: 13/294,555

(22) Filed: Nov. 11, 2011

(30) Foreign Application Priority Data
Dec. 2, 2010 (EP) 10 450 186.1

(51) Int. Cl. H04B 15/00; H04L 27/28

(52) U.S. Cl. 375/260

(57) ABSTRACT

A method of channel estimation in an OFDM transmission system having a transmitter and a receiver according to standard IEEE 802.11x. The method includes: in the transmitter, setting an identifier in a reserved bits section of the header following the preamble in a physical layer frame; attaching a postamble at the end of said frame without altering the length information in the header; transmitting said frame over the channel, in the receiver, receiving a frame over the channel and checking a reserved bits section in the header of the received frame for the presence of the identifier; and if the identifier is detected, using the postamble and the preamble of the received frame to estimate the channel.

### CROSS-REFERENCE TO RELATED APPLICATION(S)

This application claims priority to European Patent Application No. 10 450 186.1, filed on Dec. 2, 2010, the contents of which are hereby expressly incorporated by reference.

### FIELD OF THE INVENTION

The present invention relates to a method of channel estimation in an orthogonal frequency-division multiplexing (OFDM) transmission system having a transmitter and a receiver according to standard IEEE 802.11x.

### BACKGROUND

Car-to-car and car-to-infrastructure systems are currently being standardized. All standards on the dedicated 5.9 GHz band base on IEEE 802.11 and the extensions particularly devised for vehicle use, 802.11p. These extensions are limited to halving the bandwidth, and by that having a longer cyclic prefix. In the present disclosure the term “IEEE 802.11x” refers to all variants and extensions of the basic standard IEEE 802.11.

A significant problem in the mobile radio channel is the fast variation of the channel over time. These variations need to be tracked by the receiver to achieve a trustworthy estimate of the channel in order to coherently decode the symbols. The current channel training sequence (“pilot sequence”) that is used in IEEE 802.11x is not well suited for this problem. The reason for this shortcoming in the standard was that IEEE 802.11x was initially designed for nomadic applications (WiFi on laptop computers or smart phones), where mobility is nomadic only.

Still, the IEEE 802.11x pilot pattern was chosen for the ITS standards—the reason is simply that chipsets are already available on the market. These chipsets will initially achieve only reduced performance in non-line-of-sight and highly-mobile environments. Thus, an improvement of the current standards is vital to enable robust communications for safety-related communications.

The main problem of an extension of the standard is to stay compatible with older chipsets due to the long lifetime of cars. Improvements to the standard should be backwards compatible such that already deployed chipsets do not need to be changed.

### SUMMARY

The present invention devises a method of channel estimation in an orthogonal frequency-division multiplexing (OFDM) system, which has an improved estimation performance suited for fast varying channels in vehicular environments.

In some embodiments, the present invention is a method of channel estimation in an OFDM transmission system having a transmitter and a receiver according to standard IEEE 802.11x. The method includes: in the transmitter, setting an identifier in a reserved bits section of a header following a preamble in a physical layer frame; attaching a postamble at an end of said frame without altering length information in the header; transmitting said frame over a channel; in the receiver, receiving a frame over the channel and checking a reserved bits section in the header of the received frame for the presence of the identifier; and if the identifier is detected, using the postamble and the preamble of the received frame to estimate the channel.

The identifier announcing the postamble for receivers capable of handling the postamble can be set in any of the reserved bits of the IEEE 802.11x physical layer frame header. In a first embodiment, the identifier is a flag in the reserved bit of the signal section of the header. Alternatively, the identifier is a code which is set in one or more of the reserved bits of the service bits section of the header.

The postamble can be any given set of data suited for channel estimation purposes. Preferably, the postamble is an OFDM symbol containing a known pilot pattern, as will be readily aware to the person skilled in the art. In some embodiments of the invention, the channel is estimated by 2-dimensional interpolation in time and frequency between the preamble and the postamble, for example, by a Wiener Filter.

While the method of the invention is suited for all variants of IEEE 802.11x, it is particularly suited for applications in OFDM transmission systems, according to the IEEE 802.11p standard for highly mobile environments.

### BRIEF DESCRIPTION OF THE DRAWINGS

FIG. 1 shows pilot patterns according to the IEEE 802.11x standard;

FIG. 2 shows pilot patterns according to some embodiments of the present invention;

FIG. 3 shows an exemplary incorporation of a postamble and its identifier in a physical layer frame of an OFDM transmission scheme, according to ome embodiments of the present invention; and

FIG. 4 shows the performance of the inventive method in comparison to conventional channel estimation methods.

### DETAILED DESCRIPTION

The present method is based on the IEEE 802.11 standard and all its variants, improvements and extensions, herein comprised by the general denominator “802.11x”, including standards 802.11a, 802.11b, 802.11g, 802.11n, 802.11p, etc. All IEEE documents defining those standards are herein incorporated by reference.

The invention enables the beneficial use of postambles within the framework of conventional IEEE 802.11x standards by extending the 802.11x pilot pattern. The postamble added to the frame is announced in a to-date unused packet header field. The extension is done in a transparent way, such that conventional receivers (not knowing about the new pilot pattern) maintain their performance. However, receivers taking the new pattern into account have two major advantages: (i) significantly increased receiver performance in terms of BER (bit error rate), and (ii) significantly lower receiver complexity. The result is a tremendous reduction of implementation complexity for achieving a good system performance.

The benefits of using a postamble in addition to a preamble for channel estimation purposes is known in the art per se, see e.g. US 2009/0209206 A1; S. Plass et al. (eds.), “Channel estimation by exploiting sublayer information in OFDM systems”, Multi-Carrier Spread Spectrum 2007, pp. 387-396, 2007 Springer; and S. Rossi and R. R. Muller, “Slepian-based two-dimensional estimation of time-frequency variant MIMO-OFDM channels”, IEEE Signal Process Lett., vol. 15, pp. 21-24, January 2008, the entire contents of which are hereby incorporated by reference. Pre- and postambles can e.g. be used as input to a 2-dimensional Wiener Filter estimating the channel parameters over frequency and time.

Therefore, in some embodiments of the invention, the channel is estimated by 2-dimensional interpolation in time and frequency between the preamble and the postamble, for example, by a Wiener Filter.

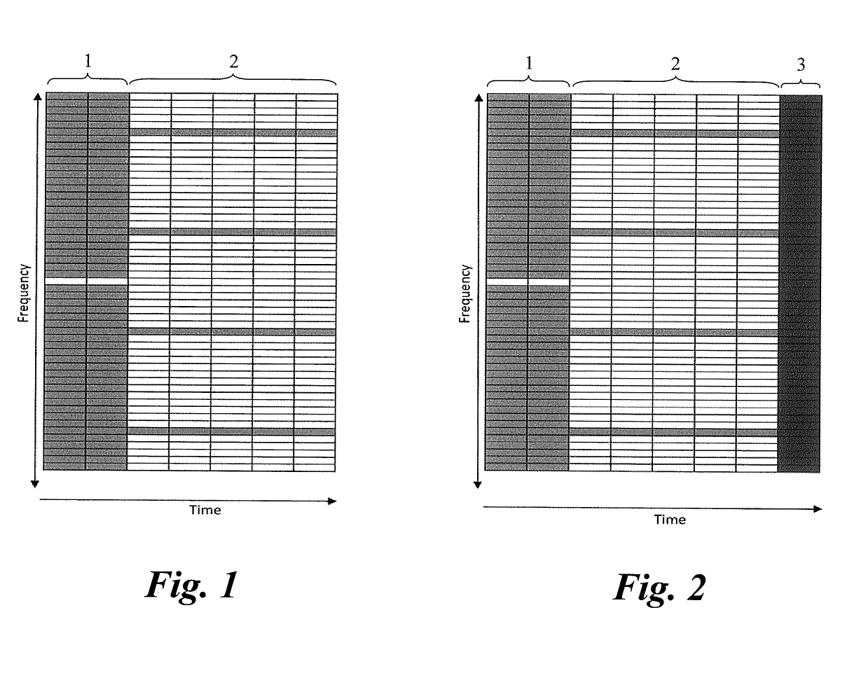

The current structure of an OFDM frame (data packet) in IEEE 802.11p is shown in FIG. 1 comprising 52 subcarriers in the frequency range over symbol time. The first two or more OFDM symbols are used as training symbols (“preamble”) containing known pilots. Then only 4 subcarriers are used as pilots for phase and clock tracking, throughout the whole frame.

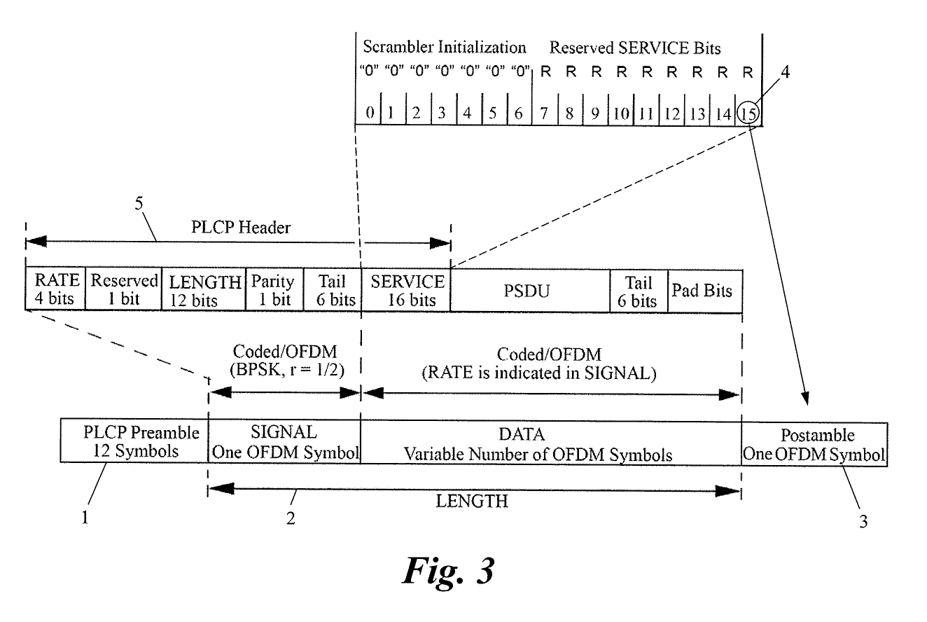

FIGS. 2 and 3 show an improved pilot pattern and an improved physical layer (PHY) frame (data packet) for an improved channel estimation method in an OFDM transmission system extending the standard IEEE 802.11x, in particular 802.11p. At the end of a conventional physical layer frame 2 preceded by a preamble 1 according to IEEE 802.11x, a postamble 3 is attached which includes one or more OFDM symbols containing a known pilot pattern. While postamble 3 does change the physical length of the frame 2, the LENGTH information in the header Physical Layer Convergence Procedure-header (PLCP) 5 of the frame 2 is not changed with respect to its conventional (FIG. 1) use and value. Therefore, conventional receivers will ignore postamble 3.

One or more of the reserved bits in the reserved bits section of the PLCP header 5 is/are used to set an identifier 4 therein which indicates the existence of postamble 3. The identifier 4 can be a flag set in a single bit of the “Reserved SERVICE Bits” section of the PLCP header 5, as shown in FIG. 3 for bit 15, or a flag set in the single “Reserved 1 bit” following the 4 RATE bits in the PLCP header 5. Alternatively, more than 1 bit could be used of the available (in total: 1+9) reserved bits of the PLCP header 5 to set a code therein (maximum code length: 1+9=10 bits), indicating the presence and preferably also coding a type of the postamble 3 used.

Extending the pilot pattern in this way has two advantages: (i) the channel can be tracked accurately; and (ii) the postamble 3 is transparent to older receivers since the latter stop receiving after the number of OFDM symbols indicated in the LENGTH field has been decoded. Such older receivers will simply observe a channel that is occupied for one or more further symbol time(s).

In an improved receiver capable of using postamble 3 in addition to preamble 1, the reserved bit(s) in the header 5 is/are checked for the presence of the identifier 4 and, if such an identifier 4 is detected, postamble 3 is used in combination with preamble 1 to estimate the channel.

Estimating the OFDM transmission channel by means of pre- and postambles 1, 3 involves the use of a 2-dimensional interpolation—in time and frequency—between the preamble 1 and the postamble 3 by means of a Wiener Filter.

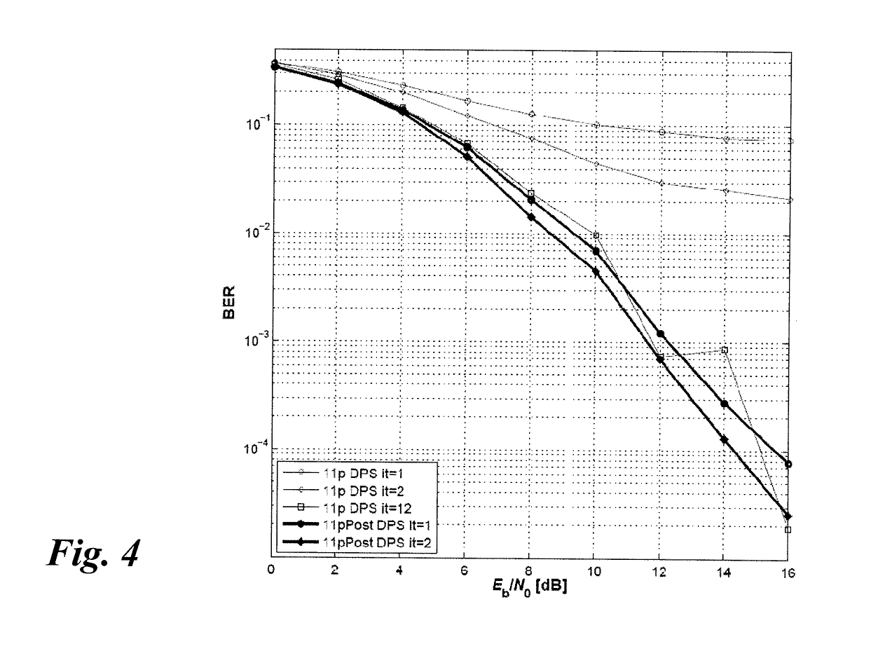

FIG. 4 shows the results of a comparison test of the new method of FIG. 3 and new pilot pattern of FIG. 2 as compared to a conventional channel estimation technique involving only preamble 1. FIG. 4 shows the bit error rate (BER) over signal-to-noise ratio (SNR) Eb/N0 for five different channel estimation methods all of which use discreet prolate spheroidal (DPS) sequences to model and estimate the channel. The first three curves labelled “11p DPS” refer to conventional channel estimation techniques with 1, 2, and 12 iterations of the Wiener Filter, respectively. The last two curves labelled “11pPost DPS” refer to two embodiments of the improved method including pre- and postambles 1, 3 with one and two iterations, respectively.

The comparison was made by means of an 802.11p link level simulator. As simulated environment, a NLOS channel with 400 ns maximum excess delay and a Doppler profile corresponding to a relative speed of 150 km/h was used. For the conventional pilot pattern of FIG. 1, the block length was 34 OFDM symbols corresponding to 200 bytes of QPSK modulated data with a code rate of ½. For the improved pilot pattern of FIG. 2, the block length was 35 OFDM symbols (because of the additional postamble 3). The implemented receiver used the theorems of “Iterative soft channel estimation and detection” disclosed i.a. in T. Zemen, C. F. Mecklenbräuker, J. Wehinger, and R. R. Müller, “Iterative joint time-variant channel estimation and multi-user detection for MC-CDMA”, IEEE Trans. Wireless Commun., vol. 5, no. 6, pp. 1469-1478, June 2006; T. Zemen, H. Hofstetter, and G. Steinböck, “Successive Slepian subspace projection in time and frequency for time-variant channel estimation”, in 14th IST Mobile and Wireless Communication Summit (IST SUMMIT), Dresden, Germany, Jun. 19-22 2005; and S. Rossi and R. R. Müller, loc. cit.; the disclosures of which are expressly incorporated herein by reference.

The simulations were performed over 100 frames. The conventional pilot pattern showed an error floor in BER for few (1 or 2) iterations. Only when increasing the number of iterations to a high number an acceptable receiver performance was achievable. In contrast thereto, for the improved channel estimation method, already the first iteration led to acceptable receiver performance, and two iterations corresponded to an optimum receiver.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

1. A method of channel estimation in an orthogonal frequency-division multiplexing (OFDM) transmission system having a transmitter and a receiver according to standard IEEE 802.11x, the method comprising:
in the transmitter, setting an identifier in a reserved bits section of a header following a preamble in a physical layer frame;
attaching a postamble at an end of said frame without altering length information in the header;
transmitting said frame over a channel;
in the receiver, receiving a frame over the channel and checking a reserved bits section in a header of the received frame for the presence of said identifier; and
if said identifier is detected, using the postamble and the preamble of the received frame to estimate the channel.

2. The method of claim 1, wherein the channel is estimated by 2-dimensional interpolation in time and frequency between the preamble and the postamble by a Wiener Filter.

3. The method of claim 1, wherein said identifier is a flag in the reserved bit of a signal section of the header.

4. The method of claim 1, wherein said identifier is a code set in one or more of reserved bits of a service bits section of the header.

5. The method of claim 1, wherein said postamble is an OFDM symbol containing a known pilot pattern.
